(19) United States
(12) Patent Application Publication
(10) Pub. No.: US 2018/0163923 A1
(43) Pub. Date: Jun. 14, 2018

(54) SYSTEM, DEVICE, AND METHOD FOR FILLING AT LEAST ONE BALLOON

(71) Applicant: Telebrands Corp., Fairfield, NJ (US)

(72) Inventor: Ajit KHUBANI, Saddle River, NJ (US)

(21) Appl. No.: 15/123,453

(22) PCT Filed: Feb. 22, 2016
(86) PCT No.: PCT/US16/18922

§ 371 Date: Sep. 2, 2016

Related U.S. Application Data
(63) Continuation of application No. 14/978,839, filed on Dec. 22, 2015, now abandoned.
(60) Provisional application No. 62/182,122, filed on Jun. 19, 2015.

(51) Int. Cl. F17C 1/00

(52) U.S. Cl. CPC F17C 1/00; B65B 2220/14

(57) ABSTRACT

An apparatus for filling a plurality of containers with a fluid-additive mixture. The apparatus including a connector configured to removably couple the apparatus to a fluid source, a plurality of coupling elements, each coupling element configured to couple a corresponding container to the apparatus, a flow path providing fluid communication between the fluid source and each of the containers coupled to the apparatus, and a mixing mechanism disposed in the flow path and configured to receive an additive and introduce the additive into the flow path. The apparatus being configured such that a fluid supplied by the fluid source flows through the flow path and the mixing mechanism, thereby creating the fluid-additive mixture and filling each of the plurality containers coupled to the apparatus with the fluid-additive mixture substantially simultaneously.

### CROSS REFERENCE TO PRIOR APPLICATIONS

The present application is the U.S. National Stage Application of International Application No. PCT/US16/18922, filed on Feb. 22, 2016, which claims the benefit of U.S. Provisional Application No. 62/182,122, filed on Jun. 19, 2015, and U.S. application Ser. No. 14/978,839, filed on Dec. 22, 2015. These applications are all hereby incorporated by reference herein in their entireties.

### FIELD

The present application generally relates to devices, apparatus, systems and methods for filling containers with a fluid. Specifically, the present application relates to automatically filling multiple balloons with a fluid mixture.

### BACKGROUND

Some containers, particularly fluid-inflatable containers such as balloons, can be difficult to fill with a fluid, especially when there is a need to fill multiple containers simultaneously and/or quickly. To make the filling of these containers easier and more efficient, various products are currently available that facilitate the filling of fluid-inflatable containers. These fluid-inflatable containers may be filled or inflated using various fluids, such as, e.g., liquids such as water, gases such as helium, or medications. Examples of fluid-inflatable containers include those used for recreational purposes, such as balloons.

Additionally, there may be times where it may be desirable to be able to introduce an additive, such as a dye or other soluble or insoluble material, to the fluid used to fill the fluid-inflatable containers. Nevertheless, it may be difficult, impossible, inefficient, or undesirable to first mix the fluid with the additive and subsequently fill the containers with the mixture. Further, many of the existing products may connect directly to a fluid source, such as a hose or faucet, thereby making it impracticable to pour a mixture to fill fluid-inflatable containers using such products.

### SUMMARY

Embodiments of the present invention can provide an apparatus for filling a plurality of containers with a fluid-additive mixture. The apparatus can include a connector configured to removably couple the apparatus to a fluid source, a plurality of coupling elements, each coupling element configured to couple a corresponding container to the apparatus, a flow path providing fluid communication between the fluid source and each of the containers coupled to the apparatus, and a mixing mechanism disposed in the flow path and configured to receive an additive and introduce the additive into the flow path. The apparatus may be configured such that a fluid supplied by the fluid source flows through the flow path and the mixing mechanism, thereby creating the fluid-additive mixture and filling each of the plurality containers coupled to the apparatus with the fluid-additive mixture substantially simultaneously.

According to some embodiments, the apparatus can further include a plurality of conduits, each container being coupled to a corresponding conduit by the corresponding coupling element. The coupling elements can be configured to automatically seal the corresponding container when the corresponding container is decoupled from the apparatus, and the containers can include balloons. Additionally, the connector can include the mixing mechanism. The mixing mechanism can include a separator which defines at least a first and a second chamber in an interior of the connector, the first and second chambers being in fluid communication, and the additive is substantially secured within the first chamber. Further, the additive can include a dye and the additive can be at least one of a pellet, a gel, and a powder.

Another embodiment of the present invention can provide a method of filling at least one balloon with a mixture of a fluid and an additive using a balloon filling apparatus. The method can include coupling the balloon filling apparatus to a fluid source via a connector of the balloon filling apparatus, activating the fluid source, introducing the additive to a fluid provided by the fluid source so that the mixture of the fluid and the additive mixture is created when the fluid source is activated, and filling the balloons with the mixture.

According to some embodiments, the apparatus can further include at least one conduit, each balloon being coupled to a corresponding conduit by the corresponding coupling element. The coupling elements can be configured to automatically seal the corresponding balloon when the corresponding balloon is decoupled from the apparatus. Additionally, the connector can include the mixing mechanism. The mixing mechanism can include a separator which defines at least a first and a second chamber in an interior of the connector, the first and second chambers being in fluid communication, and the additive is substantially secured within the first chamber. Further, the additive can include a dye.

Yet another embodiment of the present invention can provide an apparatus for filling a plurality of containers with a mixture of a fluid and an additive, The apparatus can include a connector including a first coupling element configured to removably couple the apparatus to a fluid source configured to provide the fluid. The connector can include an interior portion defining a flow path, a mixing mechanism disposed within the interior portion, an additive disposed in the mixing mechanism, and a plurality of openings each having a first end and a second end, the first and second ends being in fluid communication. The apparatus can further include a plurality of conduits coupled to each of the plurality of openings, the plurality of containers being removably coupled to the plurality of conduits via a plurality of corresponding second coupling elements, each container being in fluid communication with the flow path. Further, the apparatus can be configured such that the fluid supplied by the fluid source flows through the flow path and the mixing mechanism, thereby creating the mixture of the fluid and the additive and filling each of the plurality containers coupled to the apparatus with the mixture substantially simultaneously,

According to some embodiments, the mixing mechanism can include a separator which defines at least a first and a second chamber in an interior of the connector, the first and second chambers being in fluid communication, and the additive is substantially secured within the first chamber. Further, the coupling elements can be configured to automatically seal the corresponding container when the corresponding container is decoupled from the apparatus, and the containers can include balloons. Additionally, the additive can include a dye,

### BRIEF DESCRIPTION OF THE DRAWINGS

FIG. 1 is an illustration of an exemplary fluid filling apparatus according to embodiments of the present invention;

FIGS. 2A and 2B are a perspective views of an exemplary connector according to embodiments of the present invention;

FIG. 3A is a cross-sectional view of an exemplary fluid filling apparatus according to embodiments of the present invention; and

FIG. 3B is a top view of an exemplary fluid filling apparatus according to embodiments of the present invention.

FIG. 4 is a flow diagram of an exemplary method according to embodiments of the present invention.

### DETAILED DESCRIPTION

Embodiments of the present invention are generally directed to devices, apparatus, systems, and methods for filling containers with a fluid. Specifically, embodiments of the present invention provide an apparatus for filling multiple balloons at substantially the same time. Certain embodiments of the present invention facilitate introducing an additive to a fluid source to enable automatic filling of multiple containers in a substantially simultaneously manner with a fluid mixture. Although the embodiments of the present invention are primarily described with respect to dyes and fluid-inflatable containers, it is not limited thereto, and it should be noted that the apparatus and systems described herein may be used to fill any type of containers with any type of fluid and/or fluid mixture.

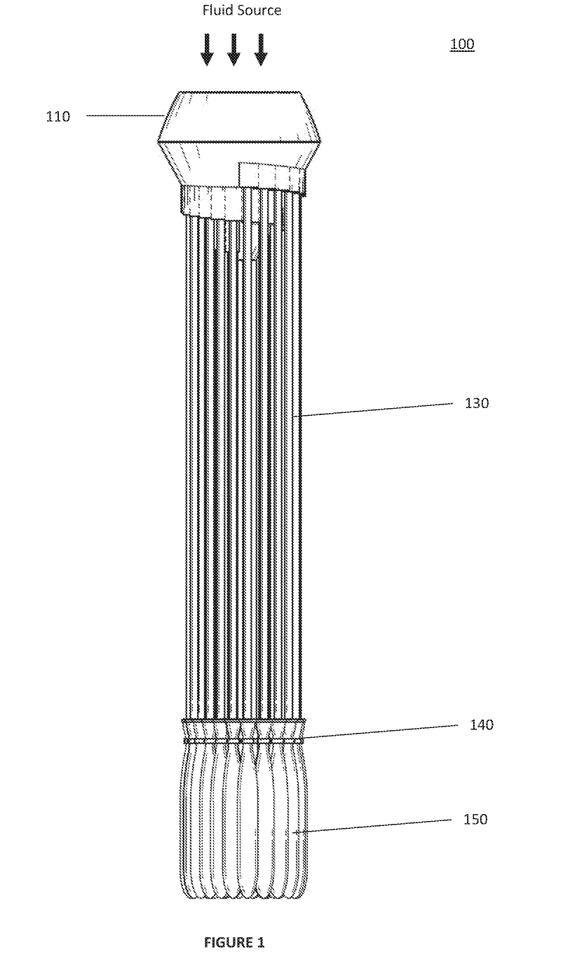

In accordance with embodiments of the present invention, FIG. 1 shows an exemplary fluid filling apparatus 100. As shown in FIG. 1, fluid filling apparatus 100 may include connector 110, conduits 130, containers 150, and fasteners 140. In use, fluid filling apparatus 100 is coupled to a fluid source, and when the fluid source is activated, the fluid passes through connector 110, conduits 130 and into containers 150, thereby filling containers 150 with the fluid at substantially the same time. Optionally, connector 110 may include an additive which may mix with the fluid as the fluid is passing through connector 110 so that containers 150 are filled with a mixture of the fluid and the additive. The fluid used to fill containers 150 may include any type of fluid, such as, water and other liquids, as well as helium and other gases.

According to embodiments of the present invention, fasteners 140 may be self-sealing. For example, fasteners 140 may automatically seal containers 150 when containers 150 are decoupled from fluid filling apparatus 100. This may be accomplished by overcoming the force that each fastener 140 exerts in coupling each respective container 150 to fluid filling apparatus 100. As this force is overcome, the respective container is detached from fluid filling apparatus 100, and fastener 140 automatically seals the end of respective container 150 that was attached to fluid filling apparatus 100. This may be accomplished, for example, by the weight of the fluid filling each container 150, manual removal of each container 150, or some other action, such as shaking fluid filling apparatus 100, to remove containers 150 from fluid filling apparatus 100. According to certain exemplary embodiments of the present invention, fasteners 140 may include rubber bands or clamps, and containers 150 may include balloons such as latex balloons. It should be noted, however, that fasteners 140 and containers 150 are not limited to these particular examples and may include any type of fastener and fillable container, respectively.

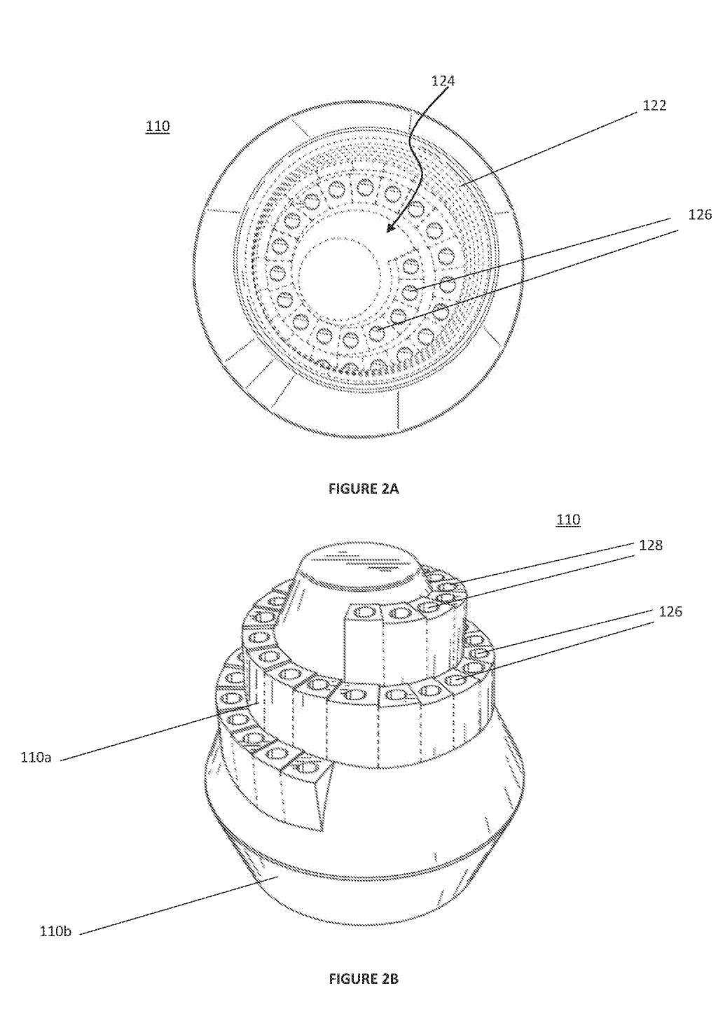

FIGS. 2A and 2B show an exemplary connector 110 according to embodiments of the present invention. As shown in FIGS. 2A and 2B, connector 110 may be substantially cylindrical and may include a first portion 110a and a second portion 110b. According to certain embodiments, first portion 110a and second portion 110b may be two distinct components that can be removably or permanently coupled together. Alternatively, according to other embodiments, first portion 110a and second portion 110b may be formed from a single piece. As shown in FIGS. 2A and 2B, connector 110 includes coupling element 122, flow path 124, and openings/channels 126. Openings/channels 126 may include an interior end and an exterior end and provides fluid communication between the exterior of connector 110 and the interior of connector 110. Further, openings/channels 126 may be dimensioned and sized to receive, or otherwise connect with, conduits 130. Coupling element 122 is configured to removably couple connector 110, and thereby couple fluid filling apparatus 100, to an upstream component, such as a fluid source. Coupling element 122 may include threads, as shown in FIG. 2A, or any other type of clamping or coupling mechanism. Although connector 110 is shown to be substantially cylindrical, connector 110 may take on any shape (e.g., square, rectangular, etc.) that may be desired. Additionally, the shape of connector 110 may differ depending on the type of upstream component that is to be used with connector 110. Further, according to certain exemplary embodiments, second portion 110b may be an adapter that enables connector 110 to be coupled to different upstream components. For example, second portion 110b may include various different types of coupling element 122 and may removably couple to first portion 110a so that connector 110 can be coupled to a variety of upstream components. Further, connector 110 may include features on the exterior to assist a user in actuating coupling element 122 to couple end cap 120 to an upstream component. According to an embodiment of the present invention, coupling element 122 may include standardized threads for receiving the threads of a standard faucet or hose.

As shown in FIG. 2A, flow path 124 and openings/channels 126 may define a flow path that the fluid may follow from the upstream component, such as a fluid source, through connector 110 to conduits 130. Preferably, conduits 130 are received in or otherwise connected to openings/channels 126. Accordingly, fluid entering connector 110 may flow through flow path 124 and through openings/channels 126 to conduits 130. The number and dimensions of the openings/channels 126 correspond to the number and dimensions of conduits 130. According to certain embodiments of the present invention, the number, size, and dimensions of openings/channels 126 may be selected in view of the number of containers 150 to be filled at one time and the speed at which they are to be filled. Accordingly, connector 110 may include any number of openings/channels 126 that is desired. As shown in FIGS. 2A and 2B, according to an embodiment of the present invention, connector 110 may include forty openings/channels 126.

As shown in FIGS. 2A and 2B, openings/channels 126 may be configured in a spiraling helical arrangement. As shown in FIG. 2B, according to an embodiment of the present invention, the exterior of connector 110 may include a plurality of faceted surfaces 128 in a spiraling helical arrangement. The configuration of faceted surfaces 128 may correspond to the position of openings/channels 126 so that the exterior end of openings/channels 126 may be disposed on faceted surfaces 128. Although FIG. 2B is shown as each faceted surface 128 have a single opening/channel 126 disposed therein, alternatively, each faceted surface 128 can have any number of openings/channels 126 disposed therein, and each faceted surface 128 could have a different number of openings/channels 126 disposed therein. For example, each faceted surface 128 could have two openings/channels 126 disposed therein, alternatively, a first stepped surface 128 could have a single opening/channel 126 disposed therein and a second stepped surface could have three openings/channels 126 disposed therein. According to other embodiments, faceted surfaces 128 can be arranged in any configuration or arrangement. Alternatively, connector 110 may not include faceted surfaces 128 and openings/channels 126 may, for example, be disposed in a smooth spiraling helix or in a spiral on a flat exterior surface.

As shown in FIG. 2A, the interior end of openings/channels 126 may also be disposed in a plurality of faceted surfaces disposed in a spiraling helical arrangement in the interior of connector 110 corresponding to the plurality of faceted surfaces 128 disposed on the exterior of connector 110. Alternatively, the interior end of openings/channels 126 may disposed on a flat surface within the interior of connector 110.

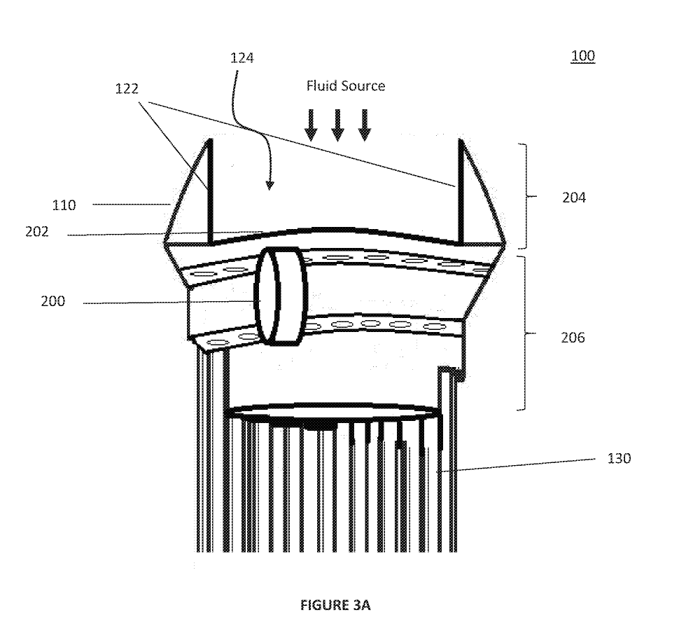

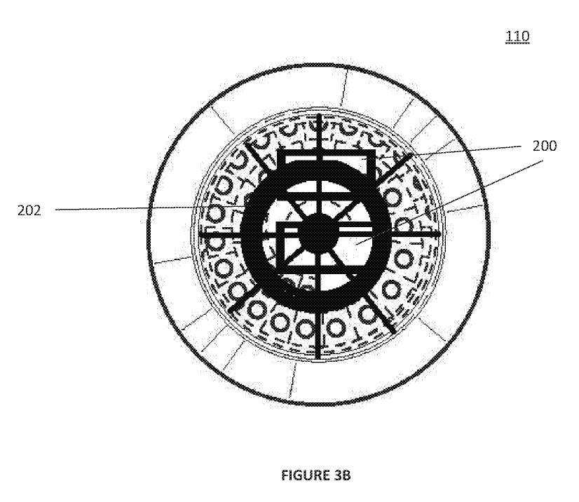

FIG. 3A shows a cross sectional view of fluid filling apparatus 100 according to embodiments of the present invention. As shown in FIG. 3A, connector 110 may be substantially cylindrical, and may define a flow path 124. Further, connector 110 preferably includes coupling element 122. Coupling element 122 may include any type of coupling mechanism, such as, e.g., threads or clamps. Coupling element 122 may be configured to couple connector 110 to an upstream component such as a fluid source. According to an embodiment of the present invention, coupling element 122 may include standardized threads for receiving the threads of a standard faucet or hose. Alternatively, coupling elements 122 may include various other types of coupling mechanisms. In operation, connector 110 is preferably coupled to a fluid source via coupling element 122. Once the fluid source is activated, the fluid travels into connector 110, through flow path 124 and into each of the openings/channels 126. The fluid then passes through openings/channels 126 to conduits 130, which are coupled to openings/channels 126. The fluid then passes through conduits 130 to fill containers 150.

As shown in FIG. 3A, connector 110 can include an additive 200 and an additive mixing mechanism. For example, additive mixing mechanism may include a separator 202 which secures additive 200 within the interior of connector 110 and defines two chambers 204 and 206, which are in fluid communication with each other, within the interior of connector 110. Separator 202 secures additive 200 within chamber 206 of the interior of connector 110 during operation of the fluid filling apparatus 100. For example, when the fluid source is activated, the fluid comes into contact with additive 200 in chamber 204 and mixes with additive 200 in chamber 206 and/or chamber 204. The mixture of the additive and the fluid passes through openings/channels 126 to conduits 130, which are coupled to openings/channels 126. The fluid and additive mixture then passes through conduits 130 to fill containers 150. Although additive 200 is shown in pellet form in FIG. 3A, additive 200 may take any form. For example, additive 200 may be in the form of, e.g., a pellet, a powder, or a gel, and may be any material or substance for which a fluid mixture is desired. According to certain exemplary embodiments, additive 200 may include any substance, such as, e.g., soda ash, bicarbonate, lactose, citric acid, mineral oil, or a dye, Additionally, although only one additive 200 is shown in FIG. 3A, any number of additives may be disposed within chamber 206 of connector 110.

FIG. 3B shows a top-view of connector 110 with the mixing mechanism. As shown in FIG. 3B, connector 110 includes separator 202 and additives 200. Preferably, separator 202 substantially secures additives 200 to the interior of connector 110 so that additives remain within chamber 206 of connector 110 while fluid filling apparatus 100 is in use. Preferably, separator 202 substantially secures additives 200 within chamber 206 of connector 110 even as additives 200 experience turbulence introduced by the fluid flowing through chamber 206. Accordingly, additives 200 substantially remain within chamber 206 while ensuring that chambers 204 and 206 remain in fluid communication with each other, It is contemplated that separator 202 may not secure additive 200 in chamber 206 permanently, For example, as the mixture is being created and additive 200 becomes smaller, portions of additive 200 may become sufficiently small that portions of additive 200 may pass through the portions of separator 202 that provide the fluid communication between chambers 204 and 206 into chamber 204. Although separator 202 is shown in FIG. 3B to have a star configuration with an annular ring and a circular center, separator 202 may include any mechanism that can secure additives 200 within chamber 206 while maintaining fluid communication between chambers 204 and 206, For example, separator 202 can include a mesh, a component with holes or openings in any configuration, etc.

In use, connector 110 may be coupled to a fluid source via coupling element 122. When the fluid source is activated, the fluid flows through flow path 124 of connector 110. The fluid then chamber 206 of connector 110 and interacts with additive 200. As the fluid mixes with additive 200, the mixture exits chamber 206 and enters exits chamber 206 through openings/channels 126. From there, the mixture flows through openings/channels 126 to conduits 130. The mixture then passes through conduits 130 to containers 150, thereby automatically filling containers 150 with a mixture of the fluid and additive 200 in a substantially simultaneous manner.

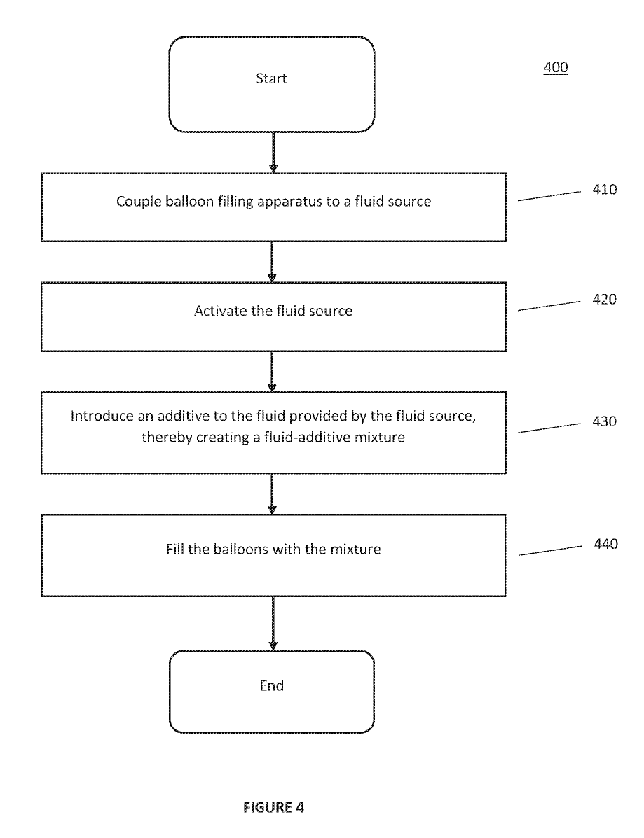

FIG. 4 shows an exemplary method 400 in accordance with embodiments of the present invention. According to certain embodiments, method 400 may be performed, for example, using fluid filling apparatus 100. As shown in FIG. 4, in step 410, a balloon filling apparatus can be coupled to a fluid source. If method 400 is being performed using fluid filling apparatus 100, this can include coupling connector 110 via coupling elements 122 to a fluid source. In step 420, the fluid source can be activated. In step 430, an additive can be introduced to the fluid provided by the fluid source, thereby creating a fluid-additive mixture. If method 400 is being performed using fluid filling apparatus 100, this can include introducing an additive using a mixing mechanism, such as those described herein. For example, the fluid can come into contact with additive 200 in chamber 204 and mix with additive 200 in chamber 206 and/or chamber 204, thereby creating the fluid-additive mixture. In step 440, the balloons can be filled with the fluid-additive mixture. With respect to fluid filling apparatus 100, after the mixture of the fluid-additive is created, it can pass through openings/channels 126 to conduits 130, which are coupled to openings/channels 126, and then pass through conduits 130 to fill containers 150.

The embodiments and examples shown above are illustrative, and many variations can be introduced to them without departing from the spirit of the disclosure or from the scope of the appended claims. For example, elements and/or features of different illustrative and exemplary embodiments herein may be combined with each other and/or substituted with each other within the scope of the disclosure. For a better understanding of the disclosure, reference should be had to the accompanying drawings and descriptive matter in which there is illustrated exemplary embodiments of the present invention.

What is claimed:

1. An apparatus for filling a plurality of containers with a fluid-additive mixture, the apparatus comprising:
a connector configured to removably couple the apparatus to a fluid source;
a plurality of coupling elements, each coupling element configured to couple a corresponding container to the apparatus;
a flow path providing fluid communication between the fluid source and each of the containers coupled to the apparatus; and
a mixing mechanism disposed in the flow path and configured to receive an additive and introduce the additive into the flow path,
wherein the apparatus is configured such that a fluid supplied by the fluid source flows through the flow path and the mixing mechanism, thereby creating the fluid-additive mixture and filling each of the plurality containers coupled to the apparatus with the fluid-additive mixture substantially simultaneously, and
wherein the additive includes a dye.

2. An apparatus for filling a plurality of containers with a fluid-additive mixture, the apparatus comprising:
a connector configured to removably couple the apparatus to a fluid source;
a plurality of coupling elements, each coupling element configured to couple a corresponding container to the apparatus;
a flow path providing fluid communication between the fluid source and each of the containers coupled to the apparatus; and
a mixing mechanism disposed in the flow path and configured to receive an additive and introduce the additive into the flow path,
wherein the apparatus is configured such that a fluid supplied by the fluid source flows through the flow path and the mixing mechanism, thereby creating the fluid-additive mixture and filling each of the plurality containers coupled to the apparatus with the fluid-additive mixture substantially simultaneously, and
wherein the additive includes at least one of a pellet, a gel, and a powder.

3. An apparatus for filling a plurality of containers with a fluid-additive mixture, the apparatus comprising:
a connector configured to removably couple the apparatus to a fluid source, the connector including a mixing mechanism disposed in the flow path and configured to receive an additive and introduce the additive into a flow path providing fluid communication between the fluid source and each of the containers coupled to the apparatus;
a plurality of coupling elements, each coupling element configured to couple a corresponding container to the apparatus;
wherein the apparatus is configured such that a fluid supplied by the fluid source flows through the flow path and the mixing mechanism, thereby creating the fluid-additive mixture and filling each of the plurality containers coupled to the apparatus with the fluid-additive mixture substantially simultaneously, and
wherein the mixing mechanism includes a separator which defines at least a first and a second chamber in an interior of the connector, the first and second chambers being in fluid communication.

4. The apparatus of claim 3, wherein the additive is substantially secured within the first chamber.

5. A method of filling at least one balloon with a mixture of a fluid and an additive using a balloon filling apparatus, comprising:
coupling the balloon filling apparatus to a fluid source via a connector of the balloon filling apparatus;
activating the fluid source;
introducing the additive to a fluid provided by the fluid source so that the mixture of the fluid and the additive mixture is created within the balloon filling apparatus when the fluid source is activated; and
filling the balloons with the mixture using the balloon filling apparatus.

6. The method of claim 5, wherein the additive includes a dye.

7. The method of claim 5, wherein the connector includes a mixing mechanism configured to receive the additive.

8. The method of claim 7, wherein the mixing mechanism includes a separator which defines at least a first and a second chamber in an interior of the connector, the first and second chambers being in fluid communication.

9. The method of claim 8, wherein the additive is substantially secured within the first chamber.

10. The method of claim 5, wherein the balloon filling apparatus includes a least one conduit, each of the at least one balloons being coupled to a corresponding conduit by a corresponding coupling element.

11. The method of claim 10, wherein each coupling element is configured to automatically seal the corresponding balloon when the corresponding balloon is decoupled from the conduit.

12. An apparatus for filling a plurality of containers with a mixture of a fluid and an additive, the apparatus comprising:
a connector including a first coupling element configured to removably couple the apparatus to a fluid source configured to provide the fluid, the connector including:
an interior portion defining a flow path,
a mixing mechanism disposed within the interior portion,
an additive disposed in the mixing mechanism, and
a plurality of openings each having a first end and a second end, the first and second ends being in fluid communication,
a plurality of conduits coupled to each of the plurality of openings, the plurality of containers being removably coupled to the plurality of conduits via a plurality of corresponding second coupling elements, each container being in fluid communication with the flow path,
wherein the apparatus is configured such that the fluid supplied by the fluid source flows through the flow path and the mixing mechanism, thereby creating the mixture of the fluid and the additive and filling each of the plurality containers coupled to the apparatus with the mixture substantially simultaneously.

13. The apparatus of claim 12, wherein the additive includes a dye.

14. The apparatus of claim 12, wherein the mixing mechanism includes a separator which defines at least a first and a second chamber in the interior portion of the connector, the first and second chambers being in fluid communication.

15. The apparatus of claim 14, wherein the additive is substantially secured within the first chamber.

16. The apparatus of claim 12, wherein each second coupling element is configured to automatically seal the corresponding container when the corresponding container is decoupled from the apparatus.

17. The apparatus of claim 12, wherein the plurality of containers include a plurality of balloons.
